(19) United States
(12) Patent Application Publication
(10) Pub. No.: US 2025/0328948 A1
(43) Pub. Date: Oct. 23, 2025

(54) VEHICLE ENVIRONMENTAL IMPACT CALCULATOR SYSTEMS AND METHODS

(71) Applicant: State Farm Mutual Automobile Insurance Company, Bloomington, IL (US)

(72) Inventor: Susan Roth, Normal, IL (US)

(21) Appl. No.: 19/070,056

(22) Filed: Mar. 4, 2025

Related U.S. Application Data
(60) Provisional application No. 63/636,282, filed on Apr. 19, 2024.

(51) Int. Cl. G06Q 30/0601

(52) U.S. Cl. CPC G06Q 30/0631

(57) ABSTRACT

A computer system is provided that may be programmed to generating environmental impact predictions for vehicles. The system may: (1) prompt, via a user interface displayed by a user device associated with a user, the user to input at least one target vehicle model; (2) receive, from the user device, the at least one target vehicle model; (3) retrieve, from at least one data source, driver data relating to driving habits of the user; (4) populate a data form stored in the at least one memory device with the retrieved driving data; (5) generate, using an artificial intelligence model, a recommendation relating to the at least one target vehicle model based upon the populated data form, wherein the artificial intelligence model is trained based upon historical driver data relating to a plurality of drivers; and/or (6) cause the user device to display the generated recommendation within the user interface.

### CROSS-REFERENCE TO RELATED APPLICATIONS

This application claims priority to U.S. Provisional Patent Application No. 63/636,282, filed Apr. 19, 2024, entitled “VEHICLE ENVIRONMENTAL IMPACT CALCULATOR SYSTEMS AND METHODS,” the entire contents of which is hereby incorporated herein by reference in its entirety.

### FIELD OF THE DISCLOSURE

The field of the disclosure relates generally to vehicles, and more specifically, to a computing system and associated user interfaces for user-specific environmental impact predictions for vehicles.

### BACKGROUND

Various factors may influence an environmental impact of a particular vehicle. These factors may often be highly-specific to an individual driver. For example, driving habits, a location where the individual typically drives, and/or the type of vehicle used or required by the individual (e.g., performance and/or cargo capacity) may all influence the environmental impact of the vehicle being used.

Individuals may desire such information when considering purchasing a “green” vehicle (e.g., an electric vehicle (EV), hybrid-electric vehicle (HEV), and/or other alternative energy vehicle). For example, when deciding what type of vehicle to purchase, a consumer may want to know whether any potentially higher upfront costs of purchasing the vehicle are worth it, in view of the environmental benefits and/or future cost savings (e.g., lower fuel costs) of that vehicle. Conventional computer systems generally may not be capable of gathering user-specific information such as driving data and presenting such information that enables an individual considering purchasing a green vehicle to make this determination. Conventional techniques may include additional inefficiencies, encumbrances, ineffectiveness, and/or other drawbacks as well.

### BRIEF DESCRIPTION

The present embodiments may relate to, inter alia, a computer system that can collect data relating to an individual driver, generate recommendations based upon this data, and present these recommendations in an easy-to-understand format. For instance, the present embodiments may include computer systems and computer-based methods that retrieve data (referred to herein as “driver data”) relating to driving habits of a user. This driver data may be obtained from sensors, such as sensors onboard a user device (e.g., a smart phone) carried by the user and/or onboard a vehicle of the user (e.g., a telematics device and/or sensors integrated into the vehicle itself). The driver data may also be self-reported by the user, for example, by responding to prompts and/or filling out forms presented within a user interface of a mobile application executed by the user device of the user. This data may be used to populate a data from, which as described herein, may be used to generate user-specific environmental impact predictions and recommendations relating to vehicles being considered by the user.

The user may input one or more target vehicle models, and the system may query a machine learning and/or AI model, such as a large language trained generative AI model, to generate predictions and recommendations relating to the target vehicle models. For example, the model may generate recommendations to proceed or not proceed with acquiring a target vehicle model or predict periodic costs or environmental impacts (e.g., carbon and/or other pollution emissions) associated with the target vehicle that are personalized to the driver's own driving and other lifestyle habits. The use of the generative AI model (and/or other AI and/or machine learning techniques) may be available in various mediums such as a computer and/or mobile application, chat screens, web page, voice interaction with a voice chat-capable connected home device, voice bots or chat bots, ChatGPT bots, and/or social media messaging. The system may include less, or alternate functionality, including that discussed elsewhere herein.

In one aspect, a computer system for generating environmental impact predictions for vehicles may be provided. The system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another and each may operate as an input and/or output device. For example, in one instance, the computer system may be programmed to: (1) prompt, via a user interface displayed by a user device associated with a user, the user to input at least one target vehicle model; (2) receive, from the user device, the at least one target vehicle model; (3) retrieve, from at least one data source, driver data relating to driving habits of the user; (4) populate a data form stored in the at least one memory device with the retrieved driving data; (5) generate, using an artificial intelligence model, a recommendation relating to the at least one target vehicle model based upon the populated data form, wherein the artificial intelligence model is trained based upon historical driver data relating to a plurality of drivers; and/or (6) cause the user device to display the generated recommendation within the user interface. The computer system may include additional, less, or alternate functionality, including that discussed elsewhere herein.

In another aspect, a computing device for generating environmental impact predictions for vehicles may be provided. The computing device may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the computing device may include at least one processor and at least one memory device. The at least one processor may be configured to: (1) prompt, via a user interface displayed by a user device associated with a user, the user to input at least one target vehicle model; (2) receive, from the user device, the at least one target vehicle model; (3) retrieve, from at least one data source, driver data relating to driving habits of the user; (4) populate a data form stored in the at least one memory device with the retrieved driving data; (5) generate, using an artificial intelligence model, a recommendation relating to the at least one target vehicle model based upon the populated data form, wherein the artificial intelligence model is trained based upon historical driver data relating to a plurality of drivers; and/or (6) cause the user device to display the generated recommendation within the user interface. The computing device may have additional, less, or alternate functionality, including that discussed elsewhere herein.

In yet another aspect, a computer-implemented method for generating environmental impact predictions for vehicles may be provided. The method may be implemented using one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the computer-implemented method may be performed by a computing device including at least one processor and at least one memory device. The method may include, via the at least one processor: (1) prompting, via a user interface displayed by a user device associated with a user, the user to input at least one target vehicle model; (2) receiving, from the user device, the at least one target vehicle model; (3) retrieving, from at least one data source, driver data relating to driving habits of the user; (4) populating a data form stored in the at least one memory device with the retrieved driving data; (5) generating, using an artificial intelligence model, a recommendation relating to the at least one target vehicle model based upon the populated data form, wherein the artificial intelligence model is trained based upon historical driver data relating to a plurality of drivers; and/or (6) causing the user device to display the generated recommendation within the user interface. The method may have additional, less, or alternate actions, including that discussed elsewhere herein.

In still another aspect, a non-transitory computer readable medium having computer-executable instructions embodied thereon may be provided. The instructions may be implemented using one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, when executed by at least one processor, the computer-executable instructions cause the at least one processor to: (1) prompt, via a user interface displayed by a user device associated with a user, the user to input at least one target vehicle model; (2) receive, from the user device, the at least one target vehicle model; (3) retrieve, from at least one data source, driver data relating to driving habits of the user; (4) populate a data form stored in the at least one memory device with the retrieved driving data; (5) generate, using an artificial intelligence model, a recommendation relating to the at least one target vehicle model based upon the populated data form, wherein the artificial intelligence model is trained based upon historical driver data relating to a plurality of drivers; and/or (6) cause the user device to display the generated recommendation within the user interface. The computer readable medium may have instructions that direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed herein. However, it should be understood that the present embodiments are not limited to the precise arrangements and/or instrumentalities shown herein.

FIG. 1 illustrates an exemplary computer system for generating environmental impact predictions for vehicles in accordance with the present disclosure.

FIG. 2 depicts an exemplary configuration of a client computer device in accordance with one embodiment of the present disclosure.

FIG. 3 depicts an exemplary configuration of a server computing device in accordance with one embodiment of the present disclosure.

FIG. 4 illustrates an exemplary computing device and computer network for building, training, deploying, and re-training computer models including AI models for use with the system shown in FIG. 1.

FIG. 5A depicts a flow chart of an exemplary computer-implemented method for generating environmental impact predictions for vehicles using the system shown in FIG. 1.

FIG. 5B is a continuation of the flow chart shown in FIG. 5A.

FIG. 5C is a continuation of the flow chart shown in FIGS. 5A and 5B.

FIG. 6 depicts an exemplary user interface that may be presented using the systems shown in FIG. 1 in accordance with one embodiment of the present disclosure.

FIG. 7 depicts an exemplary user interface that may be presented using the systems shown in FIG. 1 in accordance with one embodiment of the present disclosure.

FIG. 8 depicts an exemplary user interface that may be presented using the systems shown in FIG. 1 in accordance with one embodiment of the present disclosure.

FIG. 9 depicts an exemplary user interface that may be presented using the systems shown in FIG. 1 in accordance with one embodiment of the present disclosure.

FIG. 10 depicts an exemplary user interface that may be presented using the systems shown in FIG. 1 in accordance with one embodiment of the present disclosure.

FIG. 11 depicts an exemplary user interface that may be presented using the systems shown in FIG. 1 in accordance with one embodiment of the present disclosure.

FIG. 12 depicts an exemplary user interface that may be presented using the systems shown in FIG. 1 in accordance with one embodiment of the present disclosure.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, computer systems and computer-based methods that retrieve data (referred to herein as “driver data”) relating to driving habits of a user. This driver data may be obtained from sensors, such as sensors onboard a user device (e.g., a smart phone) carried by the user and/or onboard a vehicle of the user (e.g., a telematics device and/or sensors integrated into the vehicle itself). The driver data may also be self-reported by the user, for example, by responding to prompts and/or filling out forms presented within a user interface of a mobile application executed by the user device of the user. This data may be used to populate a data form, which as described herein, may be used to generate user-specific environmental impact predictions and recommendations relating to vehicles being considered by the user.

Via the user interface of the mobile application, the user may input one or more vehicle models (referred to herein as “target vehicle models”) that the user is considering. The target vehicle models may be, for example, models of green vehicles (e.g., EV or hybrid vehicles, or other vehicles having lower carbon emissions) with which the user is considering replacing their current vehicle and/or that the user is considering purchasing. The user may desire to predict a potential environmental impact (e.g., carbon emission reductions) and/or cost savings that may result from replacing their current vehicle with a specific green vehicle model, and/or from selecting a green vehicle model instead of a non-green vehicle model, that takes into account the user's own driving habits and other user-specific information.

The system may query a machine learning model and/or AI model, such as a large language trained generative AI model, to generate predictions and recommendations relating to the target vehicle models. For example, the model may generate recommendations to proceed or not proceed with acquiring a target vehicle model, or whether more information is required to determine whether to proceed or not proceed with acquiring a target vehicle model. The model may also generate cost predictions (e.g., fuel cost savings compared to a reference vehicle and/or current vehicle of the user) or environmental impact predictions (e.g., carbon emission reductions compared to a reference vehicle and/or current vehicle of the user) that would result from acquiring a green vehicle, which in turn may be used by the model to generate these recommendations. The output of the AI model may further include computer executable instructions for controlling the user interface (e.g., within the mobile application and/or a web page) to present the generated predictions and recommendations. The use of the generative AI model may be available in various other mediums such as a computer and/or mobile application, chat screens, web page, voice interaction with a voice chat-capable connected home device, voice bots or chat bots, ChatGPT bots, and/or social media messaging.

In some embodiments, the system may be communicably coupled to a communication network and/or a financial services provider. The system may receive insurance information from the financial services provider. The system may connect an insurance policy of the user to the generated recommendations, in which the application may display potential changes to the user's insurance policy based upon implementation of the recommendations (e.g., whether a green vehicle is purchased).

In the exemplary embodiment, the system may be configured to prompt, via a user interface displayed by a user device associated with a user, the user to input at least one target vehicle model and receive a selection of at least one target vehicle from the user device. The target vehicle models may be, for example, models of green vehicles with which the user is considering replacing their current vehicle and/or that the user is considering purchasing. The user may desire to predict a potential environmental impact (e.g., carbon emission reductions) and/or cost savings that may result from replacing their current vehicle with a specific green vehicle model, and/or from selecting a green vehicle model instead of a non-green vehicle model, that takes into account the user's own driving habits and other user-specific information. The one or more target vehicle models may be selected via a search box, drop-down menu, or other input field within the user interface from a list of potential target vehicle models that have vehicle specifications stored within and/or retrievable by the system.

In the exemplary embodiment, the system may be configured to retrieve, from at least one data source, driver data relating to driving habits of the user. In some embodiments, the driver data may include telematics data (e.g., location data, accelerometer data, and/or gyroscope data) generated by sensors that characterize aspects of the user's driving (e.g., collected over a predefined period of time). For example, the user device may include sensors that generate telematics data, which the user device may transmit to the system, and/or the user device may be in communication with a vehicle and/or telematics device having sensors and may be configured to receive telematics data from the vehicle and/or telematics device and transmit the received telematics data to the system.

In certain embodiments, driver data may be input by the user via the user interface. For example, the user interface may include forms prompting the user to input certain information relating to the user's driving habits and/or other relevant information. In addition, driver data may be retrieved from other sources, such as external databases (e.g., databases maintained by insurance companies, government organizations, and/or other organizations).

In the exemplary embodiment, the system may be configured to populate a data form stored in the at least one memory device with the retrieved driving data. In some embodiments, the data form may be pre-populated with default values, predicted values, or values determined based upon sensor data, and the user may modify the data in the data form via the user interface, enabling the user to adjust any of these values and calculate or re-calculate without a need to re-enter every data field.

The data form may include various data fields configured to store driving data correlated with a potential cost and/or environmental impact associated with a target vehicle model. These data fields may include, for example, a home location (e.g., ZIP code) of the user, a number of miles the user typically drives in a day or other period, whether the user would consider using a different car for longer tips, whether the user has access to an electrical outlet at home or at work, financial information for a vehicle purchase (e.g., whether the user wishes to lease, finance, or purchase a vehicle in cash, a down payment or trade-in amount, an interest rate, and a length of loan), average gas prices in the user's area, desired percentage of time the vehicle would be in an electric mode of operation, insurance information (e.g., deductible, collision, and/or liability amounts), telematics data and/or scores determined based upon telematics data (e.g., acceleration, turning, braking, and speed), highway versus city miles, estimated gas prices, charging lifestyle (e.g., would the vehicle usually be charged at home, work, or other), electricity/grid source (e.g., whether renewable power is available for charging), and or other relevant data.

In the exemplary embodiment, the system may be configured to generate, using an artificial intelligence model, a recommendation relating to the at least one target vehicle model based upon the populated data form. The artificial intelligence model may be trained by the system based upon historical driver data relating to, for example, a large number of drivers. Feedback may be used to continually update and/or re-train the artificial intelligence model. With respect to a particular target vehicle model, the recommendation may include whether or not to purchase the target vehicle model. In some cases, the artificial intelligence model may determine that more data is necessary to generate a recommendation with sufficient confidence, and if so, the system may prompt entering additional driver data via the user interface and/or retrieve additional data from another source.

In some embodiments, the artificial intelligence model may be further configured to generate predicted values. For example, the artificial intelligence model may be configured to generate a predicted periodic cost (e.g., a monthly or yearly cost) associated with a vehicle model, such as an energy cost (e.g., cost of fuel and/or electricity), insurance cost, and/or other cost associated with a vehicle model. The artificial intelligence model may also predict values associated with environmental impact such as, for example, a predicted carbon emission for a period. These values may be used by the artificial intelligence model in generating a recommendation. For example, cost and/or environmental impact values may be computed for both a target vehicle model and a reference vehicle model (e.g., the user's current vehicle model or an average non-green vehicle model), and recommendations may be generated based upon a comparison between the predicted values associated with the different vehicle models.

In the exemplary embodiment, the system may be further configured to cause the user device to display any generated recommendations or predictions within the user interface. For example, the user interface may include an indicator representing a recommendation to purchase the at least one target vehicle model, a recommendation not to purchase the target vehicle, or that further driver data is needed to generate a recommendation. The user interface may further include, tables, charts, and/or graphs illustrating comparisons and/or potential changes in costs and/or environmental impact that would result from using a target vehicle model. In some cases, these values may be accompanied by other statistics that may make an impact of the values easier to understand by the user. For example, a predicted carbon emission reduction in tons may be accompanied by an equivalent number of trees planted and/or an equivalent number of months of climate change reversal.

The user interface may include additional information, instructions, and/or web links to resources that may assist the user in deciding on a vehicle or understanding a potential impact of acquiring a green vehicle. For example, the user interface may enable a user to view explanations of different types of green vehicles, glossaries of terminology and acronyms, current an upcoming tax incentives or rebates, information about batteries, public charging stations, infrastructure, and home charging and installation, and information on maintenance, repairs, and insurance.

In certain embodiments, the user interface may include a table that enables the user to compare different target vehicles and associated predicted values side-by-side. For example, the table may include both input values specified by the user or other retrieved driver data and predicted values. Input values or retrieved driver data may include, for example, a purchase type, a down payment or trade-in value, an interest rate, a loan length, an average gas price in the area, an average number of miles driven (e.g., in a year), a percentage of time of electric operation, insurance information (e.g., a deductible, collision, and liability amount), a MSRP of the vehicle, and/or any government incentives. Predicted values may include, for example, a break even point (e.g., an amount of time at which a total cost of ownership of the target vehicle model becomes less than that of a reference vehicle model), a total cost of ownership, a gas cost, an electricity cost, a maintenance cost, an insurance premium, an amount of carbon emissions reduced, an air quality (e.g., nitrogen oxide and/or particulate matter) improvement, fuel consumption saved, and/or noise pollution improved. The predicted values may be quantitative (e.g., a specific number) or qualitative (e.g., “a bunch per year” with respect to an air quality pollutant reduction).

### Exemplary System for Generating Recommendations

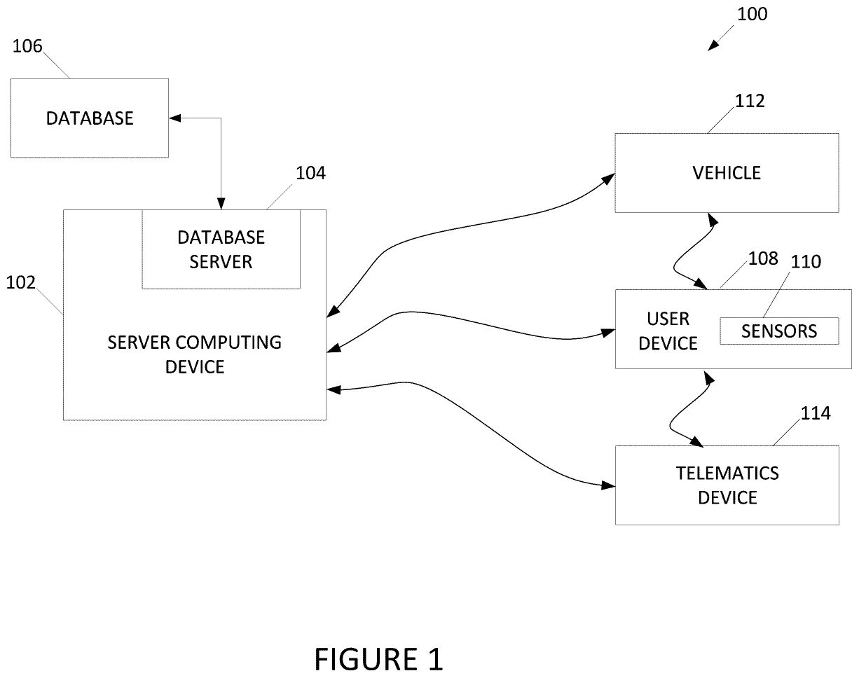

FIG. 1 illustrates an exemplary computer system 100 for generating environmental impact predictions for vehicles. In the exemplary embodiment, computer system 100 may include a server computing device 102 including a database server 104, a database 106, a user device 108 including sensors 110, a vehicle 112, and/or a telematics device 114.

In the exemplary embodiment, user devices 108 are computers that include a web browser or a software application, which enables user devices 108 to communicate with server computing device 102 using the Internet, a local area network (LAN), or a wide area network (WAN). In some embodiments, user devices 108 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User devices 108 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the exemplary embodiment, server computing device 102 is a computer that may include a web browser or a software application, which enables server computing device 102 to communicate with user devices 108 using the Internet, a local area network (LAN), or a wide area network (WAN). In some embodiments, the server computing device 102 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The server computing device 102 may be include a device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

A database server 104 is communicatively coupled to a database 106 that stores data. In one embodiment, the database 402 is a database that includes, for example, driver data, sensor data, telematics data, data relating to vehicle models, and/or any values or recommendations generated by server computing device 102. In some embodiments, the database 106 is stored remotely from the server computing device 102. In some embodiments, the database 106 is decentralized. In the example embodiment, a person can access the database 106 via user devices 108 by logging onto server computing device 102.

In the exemplary embodiment, vehicle 112 and/or telematics device 114 include computers that may include a web browser or a software application, which enables vehicle 112 and/or telematics device 114 to communicate with server computing device 102 and/or user device 108 using the Internet, a local area network (LAN), or a wide area network (WAN). In some embodiments, vehicle 112 and/or telematics device 114 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem.

In the exemplary embodiment, server computing device 102 may be configured to prompt, via a user interface displayed by user device 108 associated with a user, the user to input at least one target vehicle model and receive a selection of at least one target vehicle from user device 108. The target vehicle models may be, for example, models of green vehicles with which the user is considering replacing their current vehicle (e.g., fossil fuel vehicle) and/or that the user is considering purchasing. The user may desire to predict a potential environmental impact (e.g., carbon emission reductions) and/or cost savings that may result from replacing their current vehicle with a specific green vehicle model, and/or from selecting a green vehicle model instead of a non-green vehicle model, that takes into account the user's own driving habits and other user-specific information. The one or more target vehicle models may be selected via a search box, drop-down menu, or other input field within the user interface from a list of potential target vehicle models that have vehicle specifications stored within and/or retrievable by server computing device 102.

In the exemplary embodiment, server computing device 102 may be configured to retrieve, from at least one data source, driver data relating to driving habits of the user. In some embodiments, the driver data may include telematics data (e.g., location data, accelerometer data, and/or gyroscope data) generated by sensors that characterize aspects of the user's driving (e.g., collected over a predefined period of time). For example, user device 108 may include sensors 110 that generate telematics data, which user device 108 may transmit to server computing device 102, and/or user device 108 may be in communication with vehicle 112 and/or telematics device 114 having sensors and may be configured to receive telematics data from vehicle 112 and/or telematics device 114 and transmit the received telematics data to server computing device 102.

In certain embodiments, driver data may be input by the user via the user interface. For example, the user interface may include forms prompting the user to input certain information relating to the user's driving habits and/or other relevant information. In addition, driver data may be retrieved from other sources, such as external databases (e.g., databases maintained by insurance companies, government organizations, and/or other organizations).

In the exemplary embodiment, server computing device 102 may be configured to populate a data form stored in the at least one memory device with the retrieved driving data. In some embodiments, the data form may be pre-populated with default values, predicted values, or values determined based upon sensor data, and the user may modify the data in the data form via the user interface, enabling the user to adjust any of these values and calculate or re-calculate without a need to re-enter every data field.

The data form may include various data fields configured to store driving data correlated with a potential cost and/or environmental impact associated with a target vehicle model. These data fields may include, for example, a home location (e.g., ZIP code) of the user, a number of miles the user typically drives in a day or other period, whether the user would consider using a different car for longer tips, whether the user has access to an electrical outlet at home or at work, financial information for a vehicle purchase (e.g., whether the user wishes to lease, finance, or purchase a vehicle in cash, a down payment or trade-in amount, an interest rate, and a length of loan), average gas prices in the user's area, desired percentage of time the vehicle would be in an electric mode of operation, insurance information (e.g., deductible, collision, and/or liability amounts), telematics data and/or scores determined based upon telematics data (e.g., acceleration, turning, braking, and speed), highway versus city miles, estimated gas prices, charging lifestyle (e.g., would the vehicle usually be charged at home, work, or other), electricity/grid source (e.g., whether renewable power is available for charging), and or other relevant data.

In the exemplary embodiment, server computing device 102 may be configured to generate, using an artificial intelligence model, a recommendation relating to the at least one target vehicle model based upon the populated data form. The artificial intelligence model may be trained by server computing device 102 based upon historical driver data relating to, for example, a large number of drivers. Feedback may be used to continually update and/or re-train the artificial intelligence model. With respect to a particular target vehicle model, the recommendation may include whether or not to purchase the target vehicle model. In some cases, the artificial intelligence model may determine that more data is necessary to generate a recommendation with sufficient confidence, and if so, server computing device 102 may prompt entering additional driver data via the user interface and/or retrieve additional data from another source.

In some embodiments, the artificial intelligence model may be further configured to generate predicted values. For example, the artificial intelligence model may be configured to generate a predicted periodic cost (e.g., a monthly or yearly cost) associated with a vehicle model, such as an energy cost (e.g., cost of fuel and/or electricity), insurance cost, and/or other cost associated with a vehicle model. The artificial intelligence model may also predict values associated with environmental impact such as, for example, a predicted carbon emission for a period. These values may be used by the artificial intelligence model in generating a recommendation. For example, cost and/or environmental impact values may be computed for both a target vehicle model and a reference vehicle model (e.g., the user's current vehicle model or an average non-green vehicle model), and recommendations may be generated based upon a comparison between the predicted values associated with the different vehicle models.

In the exemplary embodiment, server computing device 102 may be further configured to cause user device 108 to display any generated recommendations or predictions within the user interface. For example, the user interface may include an indicator representing a recommendation to purchase the at least one target vehicle model, a recommendation not to purchase the target vehicle, or that further driver data is needed to generate a recommendation. The user interface may further include, tables, charts, and/or graphs illustrating comparisons and/or potential changes in costs and/or environmental impact that would result from using a target vehicle model. In some cases, these values may be accompanied by other statistics that may make an impact of the values easier to understand by the user. For example, a predicted carbon emission reduction in tons may be accompanied by an equivalent number of trees planted and/or an equivalent number of months of climate change reversal.

The user interface may include additional information, instructions, and/or web links to resources that may assist the user in deciding on a vehicle or understanding a potential impact of acquiring a green vehicle. For example, the user interface may enable a user to view explanations of different types of green vehicles, glossaries of terminology and acronyms, current an upcoming tax incentives or rebates, information about batteries, public charging stations, infrastructure, and home charging and installation, and information on maintenance, repairs, and insurance.

In certain embodiments, the user interface may include a table that enables the user to compare different target vehicles and associated predicted values side-by-side. For example, the table may include both input values specified by the user or other retrieved driver data and predicted values. Input values or retrieved driver data may include, for example, a purchase type, a down payment or trade-in value, an interest rate, a loan length, an average gas price in the area, an average number of miles driven (e.g., in a year), a percentage of time of electric operation, insurance information (e.g., a deductible, collision, and liability amount), a MSRP of the vehicle, and/or any government incentives. Predicted values may include, for example, a break even point (e.g., an amount of time at which a total cost of ownership of the target vehicle model becomes less than that of a reference vehicle model), a total cost of ownership, a gas cost, an electricity cost, a maintenance cost, an insurance premium, an amount of carbon emissions reduced, an air quality (e.g., nitrogen oxide and/or particulate matter) improvement, fuel consumption saved, and/or noise pollution improved. The predicted values may be quantitative (e.g., a specific number) or qualitative (e.g., “a bunch per year” with respect to an air quality pollutant reduction).

### Exemplary Client Device

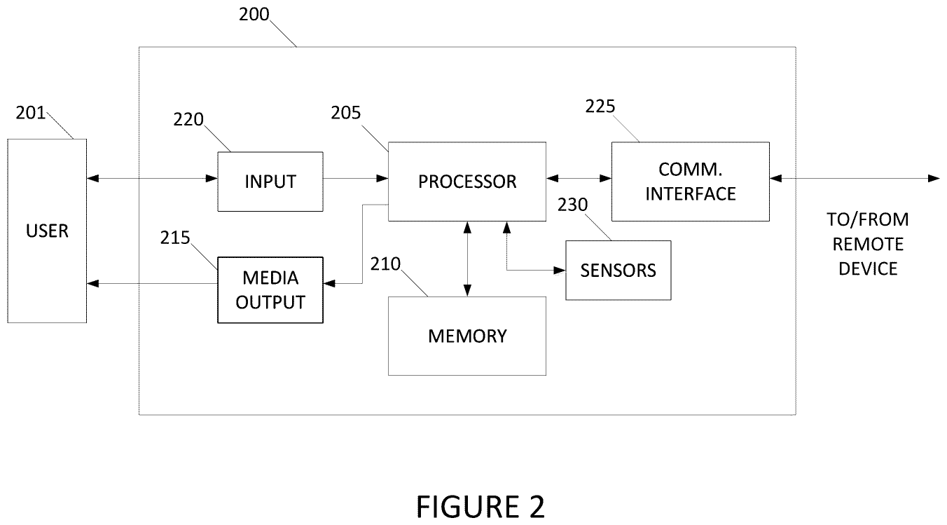

FIG. 2 depicts an exemplary configuration of a client computer device 200 shown in FIG. 1, in accordance with one embodiment of the present disclosure. User computer device 200 may be operated by a user 201. User computer device 200 may include, but is not limited to, user device 108, vehicle 112, and/or telematics device 114 (all shown in FIG. 1). User computer device 200 may include a processor 205 for executing instructions. In some embodiments, executable instructions are stored in a memory area 210. Processor 205 may include one or more processing units (e.g., in a multi-core configuration). Memory area 210 may be any device allowing information such as executable instructions and/or transaction data to be stored and retrieved. Memory area 210 may include one or more computer readable media.

User computer device 200 may also include at least one media output component 215 for presenting information to user 201. Media output component 215 may be any component capable of conveying information to user 201. In some embodiments, media output component 215 may include an output adapter (not shown) such as a video adapter and/or an audio adapter. An output adapter may be operatively coupled to processor 205 and operatively couplable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (extended Reality) headsets), and/or voice or chat bots.

In some embodiments, media output component 215 may be configured to present a graphical user interface (e.g., a web browser and/or a client application) to user 201. A graphical user interface may include, for example, an online score viewing interface for viewing predictions and recommendations. In some embodiments, user computer device 200 may include an input device 220 for receiving input from user 201. User 201 may use input device 220 to, without limitation, select a provider.

Input device 220 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 215 and input device 220.

User computer device 200 may also include a communication interface 225, communicatively coupled to a remote device such as the server computing device 102 (shown in FIG. 1). Communication interface 225 may include, for example, a wired or wireless network adapter and/or a wireless data transceiver for use with a mobile telecommunications network.

Stored in memory area 210 are, for example, computer readable instructions for providing a user interface to user 201 via media output component 215 and, optionally, receiving and processing input from input device 220. A user interface may include, among other possibilities, a web browser and/or a client application. Web browsers enable users, such as user 201, to display and interact with media and other information typically embedded on a web page or a website from the server computing device 102. A client application allows user 201 to interact with, for example, server computing device 102. For example, instructions may be stored by a cloud service, and the output of the execution of the instructions sent to the media output component 215.

Processor 205 executes computer-executable instructions for implementing aspects of the disclosure. In some embodiments, the processor 205 is transformed into a special purpose microprocessor by executing computer-executable instructions or by otherwise being programmed.

### Exemplary Server Device

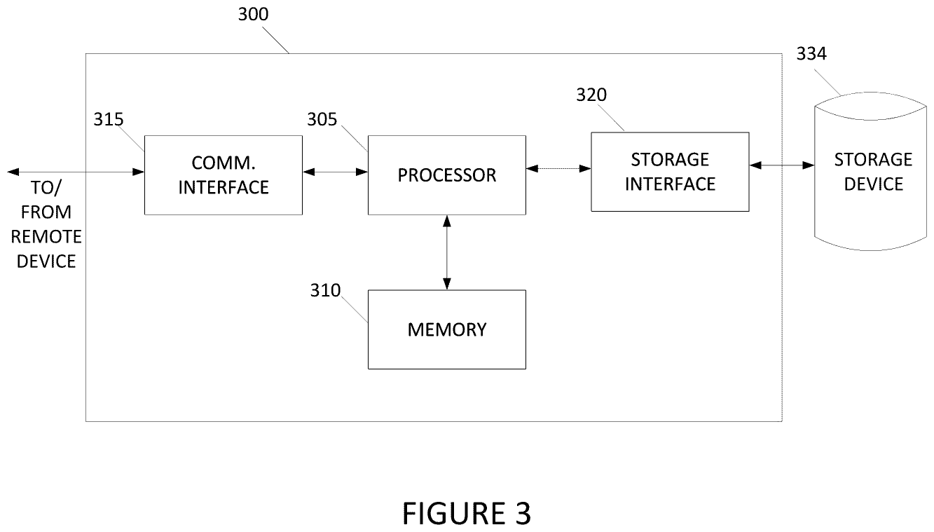

FIG. 3 depicts an exemplary configuration of a server computing device 300 as shown in FIG. 1, in accordance with one embodiment of the present disclosure. Server computer device 300 may include, but is not limited to, server computing device 102 (shown in FIG. 1). Server computer device 300 may also include a processor 305 for executing instructions. Instructions may be stored in a memory area 310. Processor 305 may include one or more processing units (e.g., in a multi-core configuration).

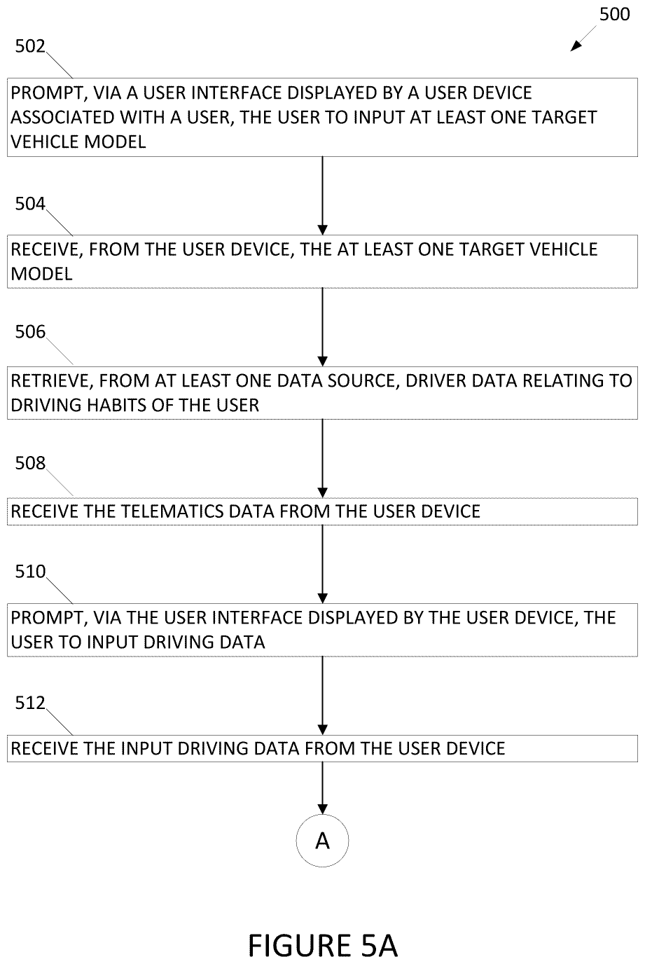

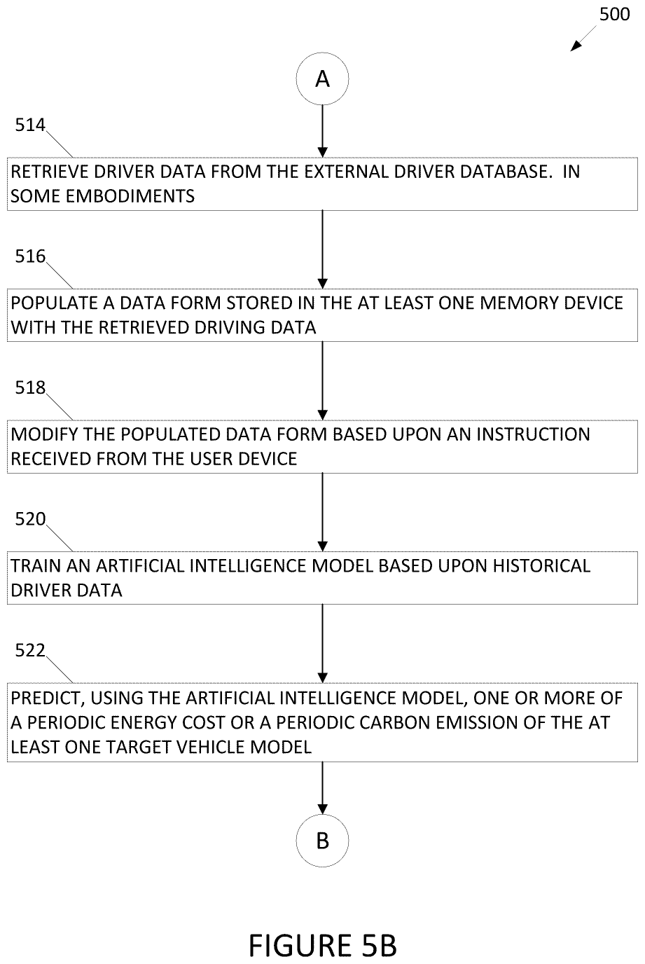

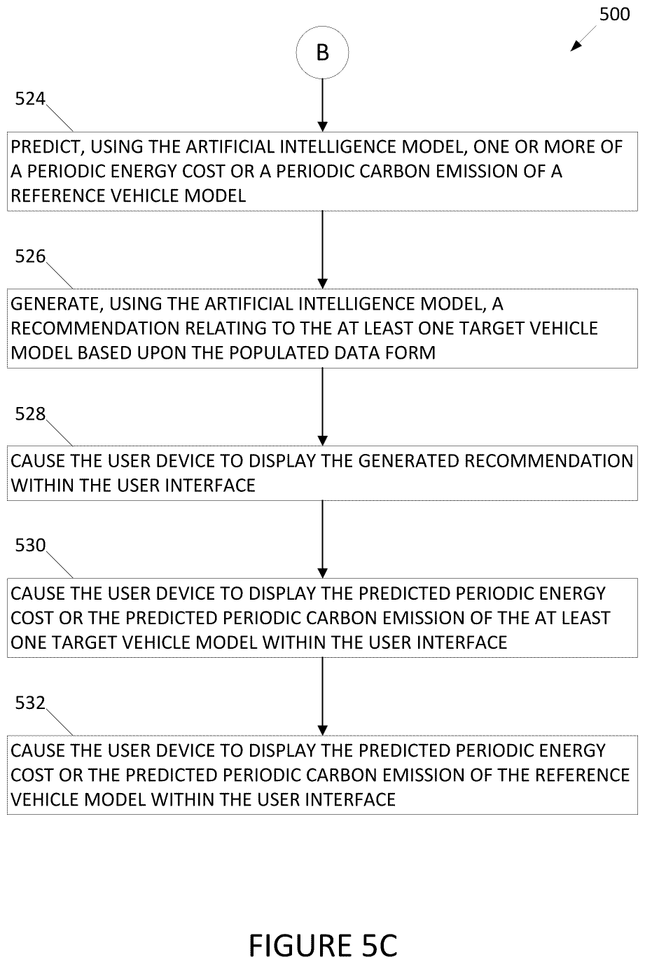

Processor 305 may be operatively coupled to a communication interface 315 such that server computer device 300 is capable of communicating with a remote device such as another server computer device 300. For example, communication interface 315 may receive requests from user device 108 via the Internet, as illustrated in FIG. 5.

Processor 305 may also be operatively coupled to a storage device 334. Storage device 334 may be any computer-operated hardware suitable for storing and/or retrieving data, such as, but not limited to, data associated with database 106 (shown in FIG. 1). In some embodiments, storage device 334 may be integrated in server computer device 300. For example, server computer device 300 may include one or more hard disk drives as storage device 334.

In other embodiments, storage device 334 may be external to server computer device 300 and may be accessed by a plurality of server computer devices 301. For example, storage device 334 may include a storage area network (SAN), a network attached storage (NAS) system, and/or multiple storage units such as hard disks and/or solid state disks in a redundant array of inexpensive disks (RAID) configuration.

In some embodiments, processor 305 may be operatively coupled to storage device 334 via a storage interface 320. Storage interface 320 may be any component capable of providing processor 305 with access to storage device 334. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 334.

Processor 305 may execute computer-executable instructions for implementing aspects of the disclosure. In some embodiments, the processor 305 may be transformed into a special purpose microprocessor by executing computer-executable instructions or by otherwise being programmed.

### Exemplary Server Computing Device

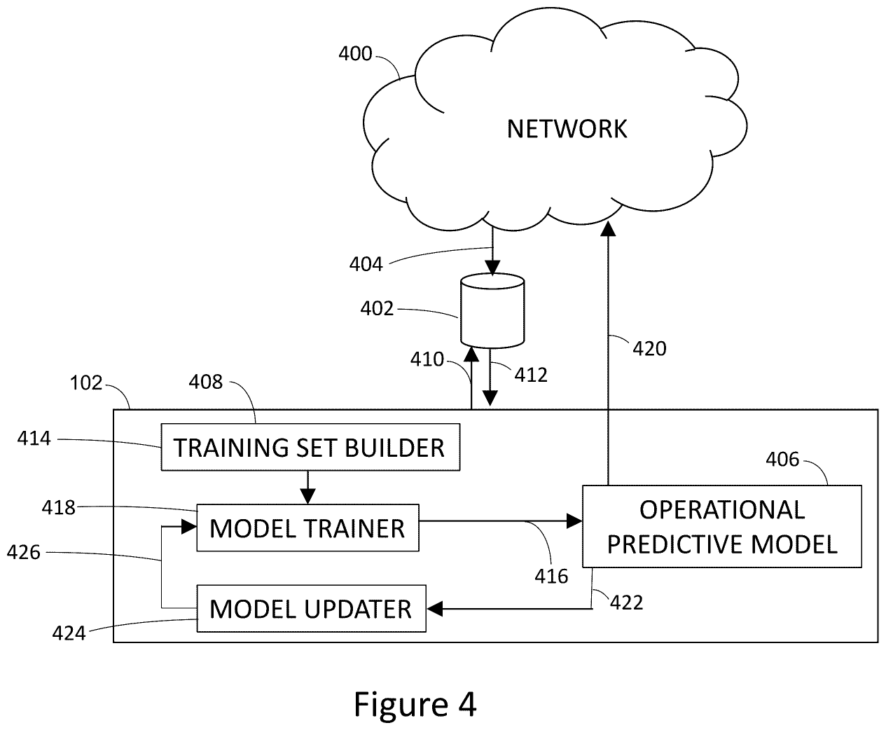

FIG. 4 is a schematic diagram illustrating further detail of server computing device 102 (shown in FIG. 1) including functionality enabling it build, train, deploy, and re-train computer models including AI models for use with the system shown in FIG. 1. Server computing device 102 may communicate with other components of system 100, such as user devices 108, via a network 400. Server computing device 102 may include and/or be in communication with a database 402 that stores data 404 including historical data and other information relevant to computing an energy score and/or generating recommendations. Data 404 received from network 400 may be stored in database 402. Server computing device 102 may be configured to use data 404 to generate an operational predictive model module 406 for generating recommendations or predictions relating to vehicles. The predictive models being built may include computer models including AI models, generative large language models, and/or machine learning models.

In exemplary embodiments, server computing device 102 includes a training set builder module 408 configured to submit one or more queries 410 to database 402 to retrieve subsets 412 of data 404, and to use those subsets 412 to build training data sets 414 for generating operational predictive model 406. For example, query 410 may be configured to retrieve certain fields from data 404 for vehicles and/or drivers having certain similar aspects.

In exemplary embodiments, training set builder module 208 may be configured to derive training data sets 414 from retrieved subsets 412. Each training data set 414 corresponds to a historical data 404 (“historical” in this context means completed in the past, as opposed to completed in real-time with respect to the time of retrieval). Each training data set 414 may include “model input” data fields along with at least one “result” data field representing historical feedback. The model input data fields represent factors that may be expected to, or unexpectedly be found during model training to, have some correlation vehicle costs and/or environmental impacts.

In exemplary embodiments, the model input data fields in training data sets 414 may be generated from data fields in subset 412 corresponding to historical data 404. In other words, a trained machine learning model 416 produced by a model trainer module 418 for use by operational predictive model module 406 is trained to make predictions based upon input values that can be generated from the data fields in data 404. Values in the model input data fields may include values copied directly from values in a corresponding data field in the retrieved subset 412, and/or values generated by modifying, combining, or otherwise operating upon values in one or more data fields in the retrieved subset 412. Values in the model input data fields may include energy usage, and other data that may correlate to energy efficiency. The use of such data fields as model input data fields facilitates the machine learning model in weighing these factors directly.

After training set builder module 408 generates training data sets 414, training set builder module 408 passes the training data sets 414 to model trainer module 418. In example embodiments, model trainer module 418 is configured to apply the model input data fields of each training data set 414 as inputs to one or more machine learning models. Each of the one or more machine learning models is programmed to produce, for each training data set 414, at least one output intended to correspond to, or “predict,” a value of the at least one result data field of the training data set 414. “Machine learning” refers broadly to various algorithms that may be used to train the model to identify and recognize patterns in existing data in order to facilitate making predictions for subsequent new input data.

Model trainer module 418 is configured to compare, for each training data set 414, the at least one output of the model to the at least one result data field of the training data set 414, and apply a machine learning algorithm to adjust parameters of the model in order to reduce the difference or “error” between the at least one output and the corresponding at least one result data field. In this way, model trainer module 418 trains the machine learning model to accurately predict the value of the at least one result data field. In other words, model trainer module 418 cycles the one or more machine learning models through the training data sets 414, causing adjustments in the model parameters, until the error between the at least one output and the at least one result data field falls below a suitable threshold, and then uploads at least one trained machine learning model 416 to operational predictive model module 406 for application to generating predictions 420. In exemplary embodiments, model trainer module 418 may be configured to simultaneously train multiple candidate machine learning models and to select the best performing candidate for each result data field, as measured by the “error” between the at least one output and the corresponding result data field, to upload to operational predictive model module 406.

In certain embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer. As model trainer module 418 cycles through the training data sets 414, model trainer module 418 applies a suitable backpropagation algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer module 418 provides an advantage by automatically discovering and properly weighting complex, second- or third-order, and/or otherwise nonlinear interconnections between the model input data fields and the at least one output. Absent the machine learning model, such connections are unexpected and/or undiscoverable by human analysts.

In exemplary embodiments, operational predictive model module 406 may compare feedback, and may route a comparison result 422 generated by comparing prediction 420 to the feedback to a model updater module 424 of server computing device 102. Model updater module 424 is configured to derive a correction signal 426 from comparison results 422 received for one or more predictions 420, and to provide correction signal 426 to model trainer module 418 to enable updating or “re-training” of the at least one machine learning model to improve performance. The retrained at least one machine learning model 416 may be periodically re-uploaded to operational predictive model module 406.

### Exemplary Computer-Implemented Method for Generating Environmental Impact Predictions for Vehicles

FIGS. 5A, 5B, and 5C depict a flow chart of an exemplary computer-implemented method 500 for generating environmental impact predictions for vehicles using system 100 (shown in FIG. 1).

In the exemplary embodiment, computer-implemented method 500 may include prompting (Block 502), via a user interface displayed by a user device associated with a user, the user to input at least one target vehicle model. In some embodiments, Block 502 may be performed by server computing device 102 (shown in FIG. 1).

In the exemplary embodiment, computer-implemented method 500 may further include receiving (Block 504), from the user device, the at least one target vehicle model. In some embodiments, Block 504 may be performed by server computing device 102 (shown in FIG. 1).

In the exemplary embodiment, computer-implemented method 500 may further include retrieving (Block 506), from at least one data source, driver data relating to driving habits of the user. In some embodiments, Block 506 may be performed by server computing device 102 (shown in FIG. 1).

In certain embodiments, the driver data may include telematics data collected by one or more sensors, and computer-implemented method 500 may further include receiving (Block 508) the telematics data from the user device. In some embodiments, Block 508 may be performed by server computing device 102 (shown in FIG. 1).

In some embodiments, computer-implemented method 500 may further include prompting (Block 510), via the user interface displayed by the user device, the user to input driving data and receiving (Block 512) the input driving data from the user device. In some embodiments, Block 510 and/or Block 512 may be performed by server computing device 102 (shown in FIG. 1).

In certain embodiments, the at least one processor is in communication with an external driver database, and computer-implemented method 500 may further include retrieving (Block 514) driver data from the external driver database. In some embodiments, Block 514 may be performed by server computing device 102 (shown in FIG. 1).

In the exemplary embodiment, computer-implemented method 500 may include populating (Block 516) a data form stored in the at least one memory device with the retrieved driving data. In some embodiments, Block 516 may be performed by server computing device 102 (shown in FIG. 1).

In some embodiments, computer-implemented method 500 may further include modifying (Block 518) the populated data form based upon an instruction received from the user device. In some embodiments, Block 518 may be performed by server computing device 102 (shown in FIG. 1).

In certain embodiments, computer-implemented method 500 may further include training (Block 520) an artificial intelligence model based upon historical driver data. In some embodiments, Block 520 may be performed by server computing device 102 (shown in FIG. 1).

In some embodiments, computer-implemented method 500 may further include predicting (Block 522), using the artificial intelligence model, one or more of a periodic energy cost or a periodic carbon emission of the at least one target vehicle model. In some embodiments, Block 522 may be performed by server computing device 102 (shown in FIG. 1).

In certain embodiments, computer-implemented method 500 may further include predicting (Block 524), using the artificial intelligence model, one or more of a periodic energy cost or a periodic carbon emission of a reference vehicle model. In some embodiments, Block 524 may be performed by server computing device 102 (shown in FIG. 1).

In the exemplary embodiment, computer-implemented method 500 may include generating (Block 526), using the artificial intelligence model, a recommendation relating to the at least one target vehicle model based upon the populated data form. In some embodiments, Block 526 may be performed by server computing device 102 (shown in FIG. 1).

In the exemplary embodiment, computer-implemented method 500 may include causing (Block 528) the user device to display the generated recommendation within the user interface. In some embodiments, Block 528 may be performed by server computing device 102 (shown in FIG. 1).

In some embodiments, computer-implemented method 500 may further include causing (Block 530) the user device to display the predicted periodic energy cost or the predicted periodic carbon emission of the at least one target vehicle model within the user interface. In some embodiments, Block 530 may be performed by server computing device 102 (shown in FIG. 1).

In certain embodiments, computer-implemented method 500 may further include causing (Block 532) the user device to display the predicted periodic energy cost or the predicted periodic carbon emission of the reference vehicle model within the user interface. In some embodiments, Block 532 may be performed by server computing device 102 (shown in FIG. 1).

### Exemplary User Interface

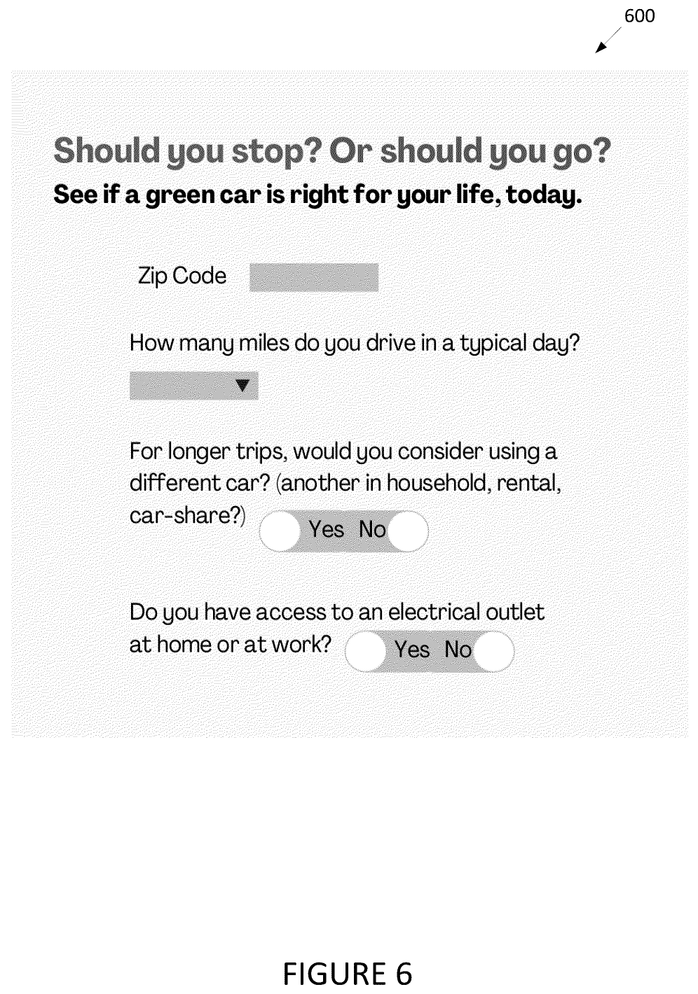

FIGS. 6 through 12 depict exemplary user interfaces that may be displayed, for example, by user device 108 (e.g., by executing a mobile application) in response to data and/or instructions received from server computing device 102. These user interfaces may facilitate a collection of driver data from a user and/or presenting of recommendations to the user.

FIG. 6 depicts an exemplary user interface 600. User interface 600 may include prompts and corresponding data fields through which a user may input driver data. Based upon this driver data, system 100 may generate recommendations with respect to green vehicles. For example, as shown in FIG. 6, the user may be prompted to input a zip code, how may miles the user drives in a typical day, whether the user would consider using a different vehicle for longer trips, and whether the user has access to an electrical outlet at home or work. Other types of driver data described herein may be collected via a similar user interface. This information may weigh in favor of or against a recommendation to purchase a green vehicle. For example, if the user does not have access to an eclectic outlet, system 100 may be less likely to recommend purchasing an EV that requires external charging.

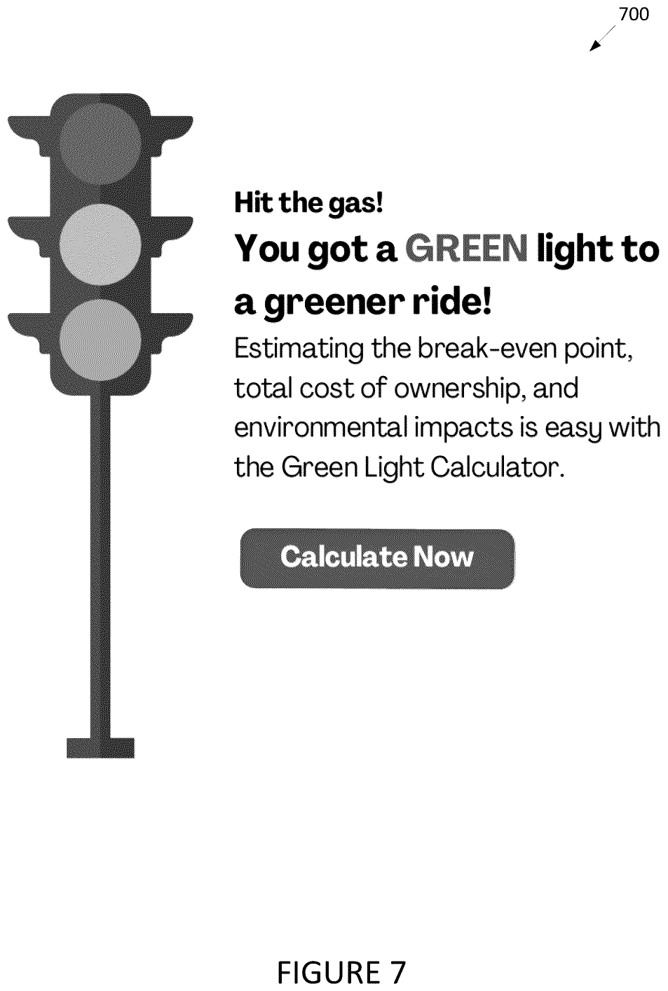

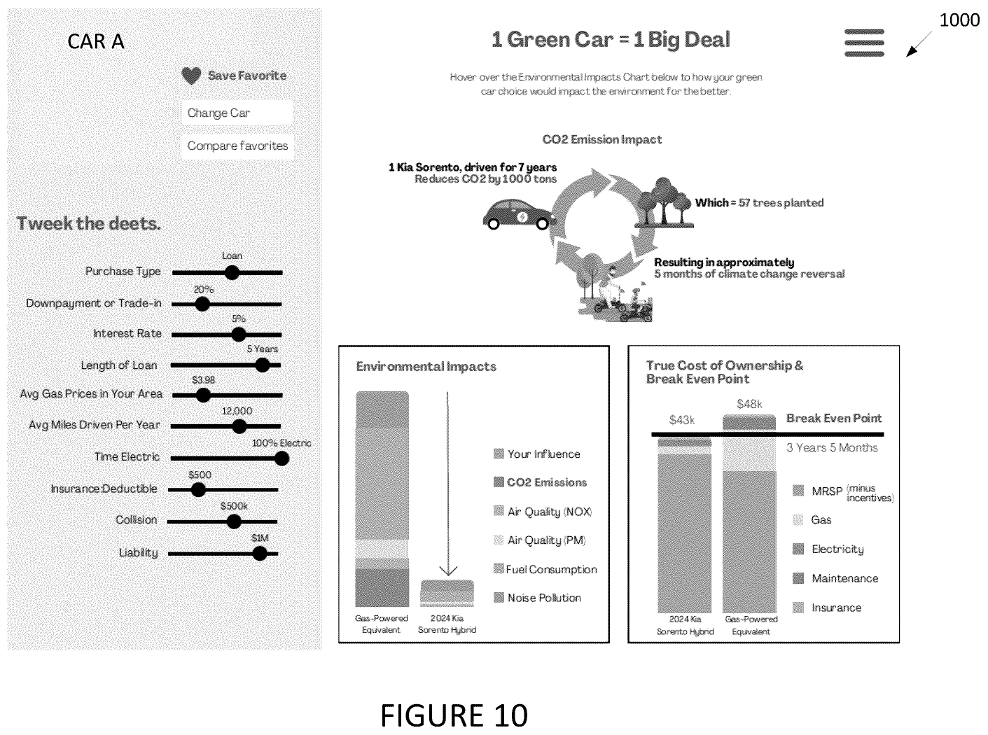

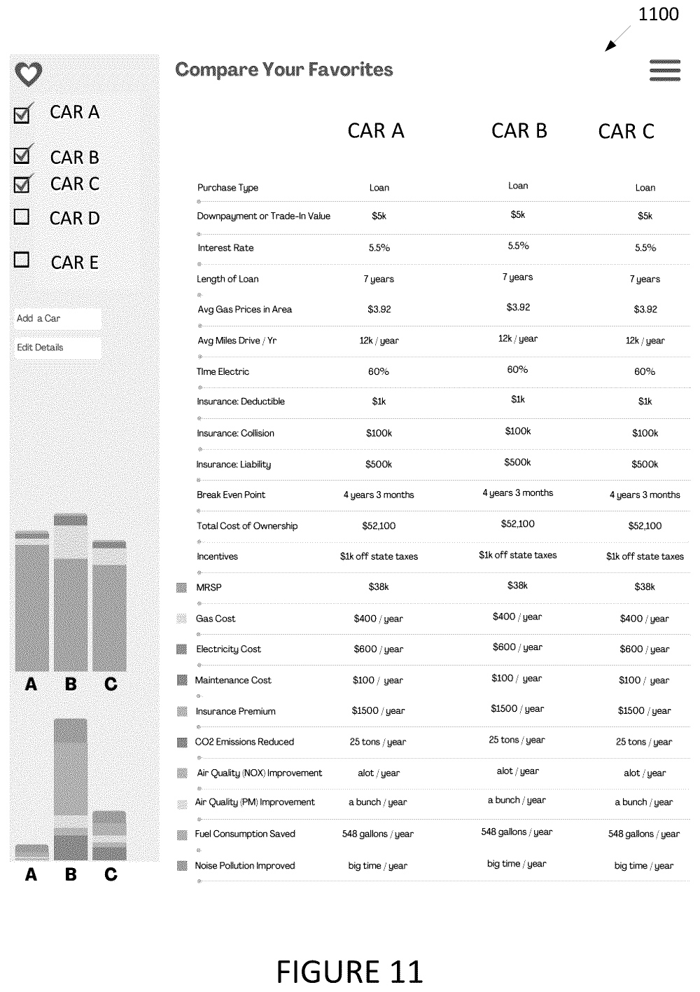

FIG. 7 depicts an exemplary user interface 700. User interface 700 may be displayed when system 100 has determined to recommend purchasing a green vehicle (e.g., based upon information input via user interface 600), and may prompt the user to select a “Calculate Now” button that may trigger display of additional features for selecting a vehicle, for example, those illustrated in FIGS. 10 and 11 described below.

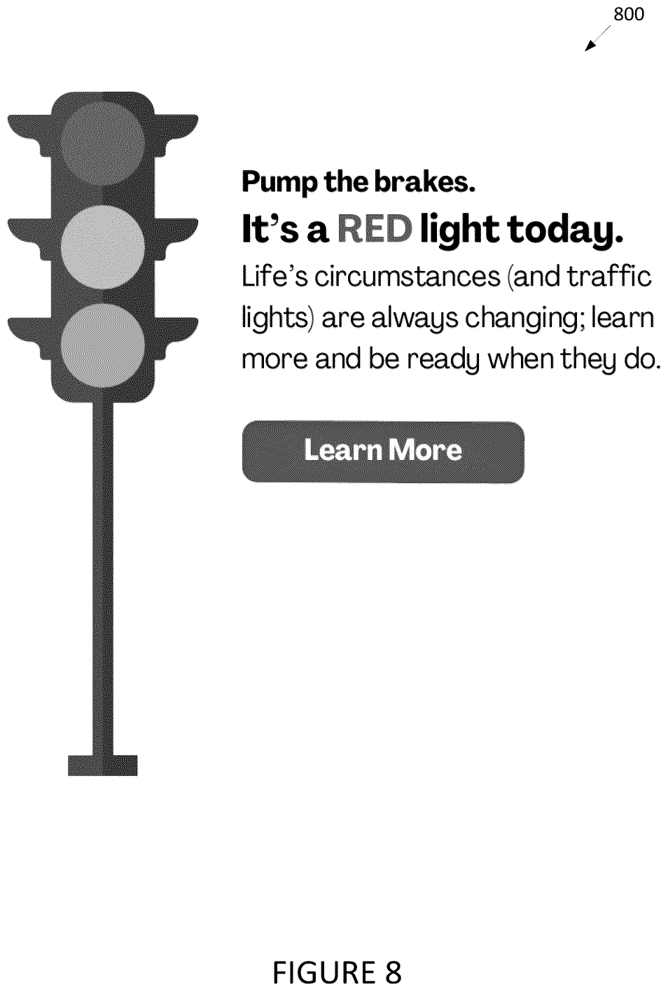

FIG. 8 depicts an exemplary user interface 800. User interface 800 may be displayed when system 100 has determined to recommend not purchasing a green vehicle (e.g., based upon information input via user interface 600), and may prompt the user to select a “Learn More” button that may trigger display additional information.

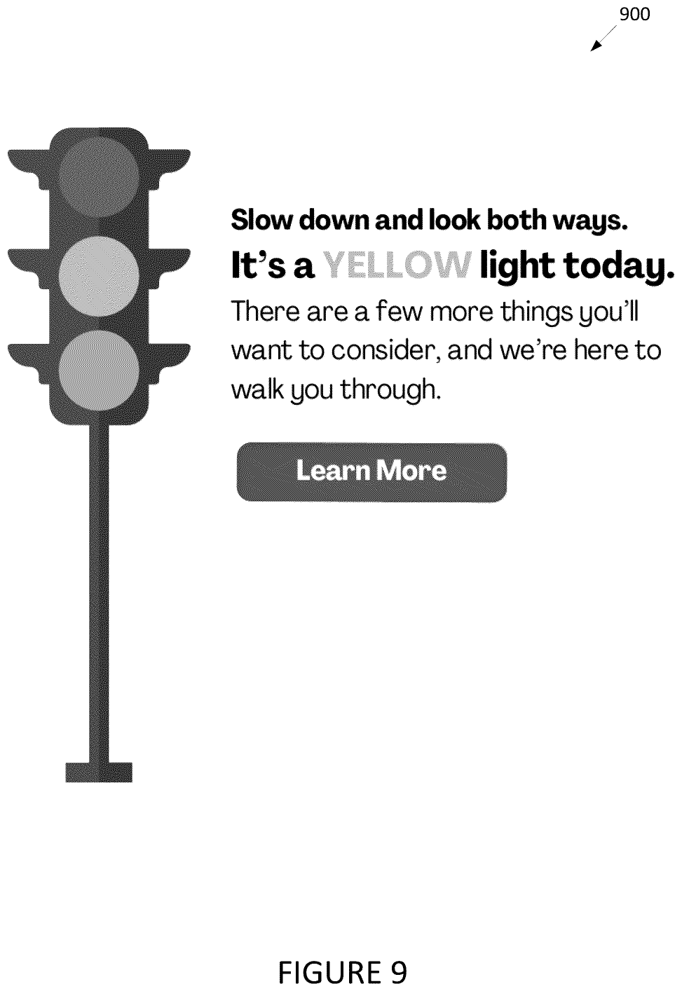

FIG. 9 depicts an exemplary user interface 900. User interface 900 may be displayed when system 100 has determined more information is necessary to determine whether to recommend purchasing a green vehicle (e.g., based upon information input via user interface 600), and may prompt the user to select a “Learn More” button that may trigger display additional information. In some embodiments, if system 100 determines more information is necessary, a prompt for additional information similar to that shown in user interface 600 may be displayed.

FIG. 10 depicts an exemplary user interface 1000. User interface displays information, such as predicted values, relating to a selected target vehicle model. The predicted values may be determined based in part upon driver data that may be input via user interface 1000 such as, for example, purchase type, down payment or trade-in, interest rate, length of loan, average gas price in the user's area, average miles driven per year, time electric, insurance deductible, collision insurance coverage, and/or liability insurance coverage. In some cases, these input fields may be pre-populated with default or predicted values, and the user may modify these values.

Predicted values displayed within user interface 1000 may include environmental impacts, such as carbon dioxide emissions, nitrous oxide air quality, particulate matter air quality, fuel consumption, and/or noise pollution, which may be displayed in a graph by comparison to a gas-powered equivalent vehicle model. The predicted values displayed within user interface 1000 may further include cost of values, such as an MSRP, gas cost, electricity cost, maintenance cost, and/or insurance cost, which may together represent a true cost of ownership of the vehicle. This may be displayed in a graph by comparison to a gas-powered equivalent vehicle model. User interface 1000 may further include a break even point determined based upon these costs, which represents an amount of time it would take for an overall cost of the target vehicle model to become less than that of a gas-powered equivalent vehicle model.

In addition to these predicted values, user interface 1000 may also include corresponding analogous values that may make the predicted values easier to understand or more impactful to the user. For example, in addition to a carbon dioxide emission reduction over a time period expressed in tons, user interface 1000 may also include an equivalent number of trees planted and/or an equivalent number of months of climate change reversal.

FIG. 11 represents an exemplary user interface 1100. User interface 1100 includes a table that enables the user to compare predicted or other values associated with different target vehicle models, which may be selected for inclusion via an “add a car” function of user interface 1100. In addition to the values themselves, user interface 1100 may include graphs, similar to those shown in user interface 1000, that may illustrate relative predicted environmental impacts and costs of the selected vehicles.

Examples of values that may be displayed within the table of user interface 1100 include purchase type, down payment or trade-in value, interest rate, length of loan, average gas price in area, average miles driven per year, time electric, insurance deductible, insurance collision coverage, insurance liability coverage, brake even point, total cost of ownership, incentives, MSRP, gas cost, electricity cost, maintenance cost, insurance premium, carbon dioxide emissions produced, air quality (nitrous oxide) improvement, air quality (particulate matter) improvement, fuel consumption saved, and/or noise pollution improved. Some of these values may be displayed with color-coded indicators linked to corresponding values displayed via the graphs shown in user interface 1100.

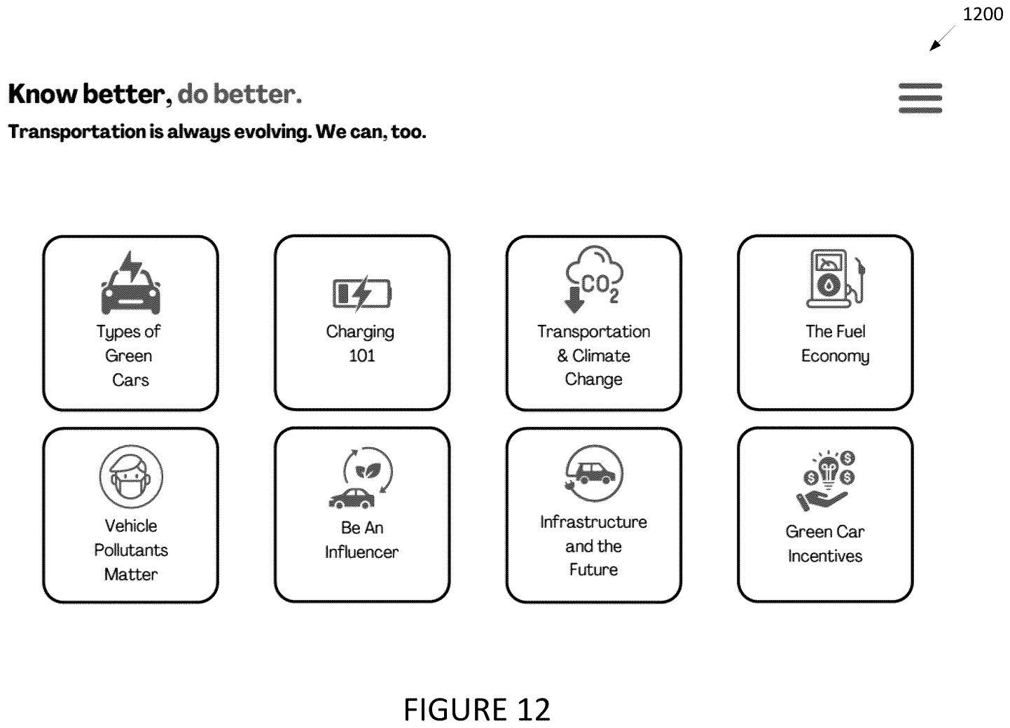

FIG. 12 represents an exemplary user interface 1200. User interface 1200 may include buttons that, when selected, trigger display of corresponding types of information, which may assist a user in determining whether to purchase a green vehicle or otherwise becoming better informed about green vehicles. Examples of subjects the buttons may include or relate to include “Types of Green Cars,” “Charging 101,” “Transportation & Climate Change,” “The Fuel Economy,” “Vehicle Pollutants Matter,” “Be An Influencer,” “Infrastructure and the Future,” and/or “Green Car Incentives.”

### EXEMPLARY EMBODIMENTS

In an exemplary embodiment, a computing device for generating environmental impact predictions for vehicles may be provided. The computing device may include at least one processor and at least one memory device. The at least one processor may be configured to: (1) prompt, via a user interface displayed by a user device associated with a user, the user to input at least one target vehicle model; (2) receive, from the user device, the at least one target vehicle model; (3) retrieve, from at least one data source, driver data relating to driving habits of the user; (4) populate a data form stored in the at least one memory device with the retrieved driving data; (5) generate, using an artificial intelligence model, a recommendation relating to the at least one target vehicle model based upon the populated data form, wherein the artificial intelligence model is trained based upon historical driver data relating to a plurality of drivers; and/or (6) cause the user device to display the generated recommendation within the user interface. The computing device may have additional, less, or alternate functionality, including that discussed elsewhere herein.

In another embodiment, the computing device as described above may further include the generated recommendation being one of a recommendation to purchase the at least one target vehicle model, a recommendation not to purchase the target vehicle, or a recommendation to input further driver data.

In another embodiment, the computing device as described above may further include the driver data being telematics data collected by one or more sensors.

In another embodiment, the computing device as described above may further include the user device having the one or more sensors, and wherein the at least one processor is configured to receive the telematics data from the user device.

In another embodiment, the computing device as described above may further include the user device being in communication with a vehicle or a telematics device including the one or more sensors, and wherein the at least one processor is further configured to receive the telematics data from the user device.

In another embodiment, the computing device as described above may further include the at least one processor being further configured to: prompt, via the user interface displayed by the user device, the user to input driving data; and receive the input driving data from the user device.

In another embodiment, the computing device as described above may further include the at least one processor being in communication with an external driver database, and wherein the at least one processor is configured to retrieve driver data from the external driver database.

In another embodiment, the computing device as described above may further include the processor being further configured to train the artificial intelligence model based upon the historical driver data.

In another embodiment, the computing device as described above may further include the processor being further configured to predict, using the artificial intelligence model, one or more of a periodic energy cost or a periodic carbon emission of the at least one target vehicle model.

In another embodiment, the computing device as described above may further include the artificial intelligence model being configured to generate the recommendation based at least in part upon the predicted periodic energy cost or the predicted periodic carbon emission of the at least one target vehicle model.

In another embodiment, the computing device as described above may further include the at least one processor being further configured to cause the user device to display the predicted periodic energy cost or the predicted periodic carbon emission of the at least one target vehicle model within the user interface.

In another embodiment, the computing device as described above may further include the at least one processor being further configured to predict, using the artificial intelligence model, one or more of a periodic energy cost or a periodic carbon emission of a reference vehicle model.

In another embodiment, the computing device as described above may further include the artificial intelligence model being configured to generate the recommendation based at least in part upon a caparison between the predicted periodic energy cost or the predicted periodic carbon emission of the at least one target vehicle model and the predicted periodic energy cost or the predicted periodic carbon emission of the reference vehicle model.

In another embodiment, the computing device as described above may further include the reference vehicle model being a current vehicle model of the user input by the user via the user interface.

In another embodiment, the computing device as described above may further include the at least one processor being further configured to cause the user device to display the predicted periodic energy cost or the predicted periodic carbon emission of the reference vehicle model within the user interface.

In another embodiment, the computing device as described above may further include the at least one processor being further configured to modify the populated data form based upon an instruction received from the user device.

In another exemplary embodiment, a computer-implemented method for generating environmental impact predictions for vehicles may be provided. The computer-implemented method may be performed by a computing device including at least one processor and at least one memory device. The method may include, via the at least one processor: (1) prompting, via a user interface displayed by a user device associated with a user, the user to input at least one target vehicle model; (2) receiving, from the user device, the at least one target vehicle model; (3) retrieving, from at least one data source, driver data relating to driving habits of the user; (4) populating a data form stored in the at least one memory device with the retrieved driving data; (5) generating, using an artificial intelligence model, a recommendation relating to the at least one target vehicle model based upon the populated data form, wherein the artificial intelligence model is trained based upon historical driver data relating to a plurality of drivers; and/or (6) causing the user device to display the generated recommendation within the user interface. The method may have additional, less, or alternate actions, including that discussed elsewhere herein.

In another embodiment, the computer-implemented method as described above may further include the generated recommendation being one of a recommendation to purchase the at least one target vehicle model, a recommendation not to purchase the target vehicle, or a recommendation to input further driver data.

In another embodiment, the computer-implemented method as described above may further include the driver data being telematics data collected by one or more sensors.

In another embodiment, the computer-implemented method as described above may further include the user device being the one or more sensors, and wherein the computer-implemented method further comprises receiving the telematics data from the user device.

In another embodiment, the computer-implemented method as described above may further include the user device being in communication with a vehicle or a telematics device including the one or more sensors, and wherein the computer-implemented method further comprises receiving the telematics data from the user device.

In another embodiment, the computer-implemented method as described above may further include prompting, via the user interface displayed by the user device, the user to input driving data; and receiving the input driving data from the user device.

In another embodiment, the computer-implemented method as described above may further include the at least one processor being in communication with an external driver database, and the computer-implemented method further comprising receiving driver data from the external driver database.

In another embodiment, the computer-implemented method as described above may further include training the artificial intelligence model based upon the historical driver data.

In another embodiment, the computer-implemented method as described above may further include predicting, using the artificial intelligence model, one or more of a periodic energy cost or a periodic carbon emission of the at least one target vehicle model.

In another embodiment, the computer-implemented method as described above may further include the artificial intelligence model being configured to generate the recommendation based at least in part upon the predicted periodic energy cost or the predicted periodic carbon emission of the at least one target vehicle model.

In another embodiment, the computer-implemented method as described above may further include causing the user device to display the predicted periodic energy cost or the predicted periodic carbon emission of the at least one target vehicle model within the user interface.

In another embodiment, the computer-implemented method as described above may further include predicting, using the artificial intelligence model, one or more of a periodic energy cost or a periodic carbon emission of a reference vehicle model.

In another embodiment, the computer-implemented method as described above may further include the artificial intelligence model being configured to generate the recommendation based at least in part upon a caparison between the predicted periodic energy cost or the predicted periodic carbon emission of the at least one target vehicle model and the predicted periodic energy cost or the predicted periodic carbon emission of the reference vehicle model.

In another embodiment, the computer-implemented method as described above may further include the reference vehicle model is a current vehicle model of the user input by the user via the user interface.

In another embodiment, the computer-implemented method as described above may further include causing the user device to display the predicted periodic energy cost or the predicted periodic carbon emission of the reference vehicle model within the user interface.

In another embodiment, the computer-implemented method as described above may further include modifying the populated data form based upon an instruction received from the user device.

In another exemplary embodiment, a non-transitory computer readable medium having computer-executable instructions embodied thereon may be provided. When executed by at least one processor, the computer-executable instructions cause the at least one processor to: (1) prompt, via a user interface displayed by a user device associated with a user, the user to input at least one target vehicle model; (2) receive, from the user device, the at least one target vehicle model; (3) retrieve, from at least one data source, driver data relating to driving habits of the user; (4) populate a data form stored in the at least one memory device with the retrieved driving data; (5) generate, using an artificial intelligence model, a recommendation relating to the at least one target vehicle model based upon the populated data form, wherein the artificial intelligence model is trained based upon historical driver data relating to a plurality of drivers; and/or (6) cause the user device to display the generated recommendation within the user interface. The computer readable medium may have instructions that direct additional, less, or alternate functionality, including that discussed elsewhere herein.

In another embodiment, the non-transitory computer readable medium having computer-executable instructions embodied thereon may further include the generated recommendation being one of a recommendation to purchase the at least one target vehicle model, a recommendation not to purchase the target vehicle, or a recommendation to input further driver data.

In another embodiment, the non-transitory computer readable medium having computer-executable instructions embodied thereon may further include the driver data being telematics data collected by one or more sensors.

In another embodiment, the non-transitory computer readable medium having computer-executable instructions embodied thereon may further include the user device having the one or more sensors, and wherein the computer-executable instructions further cause the at least one processor to receive the telematics data from the user device.

In another embodiment, the non-transitory computer readable medium having computer-executable instructions embodied thereon may further include the user device being in communication with a vehicle or a telematics device including the one or more sensors, and wherein the computer-executable instructions further cause the at least one processor to receive the telematics data from the user device.

In another embodiment, the non-transitory computer readable medium having computer-executable instructions embodied thereon may further cause the at least one processor to prompt, via the user interface displayed by the user device, the user to input driving data; and receive the input driving data from the user device.

In another embodiment, the non-transitory computer readable medium having computer-executable instructions embodied thereon may further include the at least one processor being in communication with an external driver database, and wherein the computer-executable instructions further cause the at least one processor to retrieve driver data from the external driver database.

In another embodiment, the non-transitory computer readable medium having computer-executable instructions embodied thereon may further cause the at least one processor to train the artificial intelligence model based upon the historical driver data.

In another embodiment, the non-transitory computer readable medium having computer-executable instructions embodied thereon may further cause the at least one processor to predict, using the artificial intelligence model, one or more of a periodic energy cost or a periodic carbon emission of the at least one target vehicle model.

In another embodiment, the non-transitory computer readable medium having computer-executable instructions embodied thereon may further include the artificial intelligence model being configured to generate the recommendation based at least in part upon the predicted periodic energy cost or the predicted periodic carbon emission of the at least one target vehicle model.

In another embodiment, the non-transitory computer readable medium having computer-executable instructions embodied thereon may further cause the at least one processor to cause the user device to display the predicted periodic energy cost or the predicted periodic carbon emission of the at least one target vehicle model within the user interface.

In another embodiment, the non-transitory computer readable medium having computer-executable instructions embodied thereon may further cause the at least one processor to predict, using the artificial intelligence model, one or more of a periodic energy cost or a periodic carbon emission of a reference vehicle model.

In another embodiment, the non-transitory computer readable medium having computer-executable instructions embodied thereon may further include the artificial intelligence model being configured to generate the recommendation based at least in part upon a caparison between the predicted periodic energy cost or the predicted periodic carbon emission of the at least one target vehicle model and the predicted periodic energy cost or the predicted periodic carbon emission of the reference vehicle model.

In another embodiment, the non-transitory computer readable medium having computer-executable instructions embodied thereon may further include the reference vehicle model being a current vehicle model of the user input by the user via the user interface.

In another embodiment, the non-transitory computer readable medium having computer-executable instructions embodied thereon may further cause the at least one processor to cause the user device to display the predicted periodic energy cost or the predicted periodic carbon emission of the reference vehicle model within the user interface.

In another embodiment, the non-transitory computer readable medium having computer-executable instructions embodied thereon may further cause the at least one processor to modify the populated data form based upon an instruction received from the user device.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, server computing device 102 is configured to implement machine learning, such that server computing device 102 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of vehicle or driver attributes with known characteristics or features.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments, and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computing device for generating environmental impact predictions for vehicles, the computing device comprising at least one processor and at least one memory device, the at least one processor configured to:
prompt, via a user interface displayed by a user device associated with a user, the user to input at least one target vehicle model;
receive, from the user device, the at least one target vehicle model;
retrieve, from at least one data source, driver data relating to driving habits of the user;
populate a data form stored in the at least one memory device with the retrieved driving data;
generate, using an artificial intelligence model, a recommendation relating to the at least one target vehicle model based upon the populated data form, wherein the artificial intelligence model is trained based upon historical driver data relating to a plurality of drivers; and
cause the user device to display the generated recommendation within the user interface.

2. The computing device of claim 1, wherein the generated recommendation is one of a recommendation to purchase the at least one target vehicle model, a recommendation not to purchase the target vehicle, or a recommendation to input further driver data.

3. The computing device of claim 1, wherein the driver data includes telematics data collected by one or more sensors.

4. The computing device of claim 3, wherein user device includes the one or more sensors, and wherein the at least one processor is configured to receive the telematics data from the user device.

5. The computing device of claim 3, wherein the user device is in communication with a vehicle or a telematics device including the one or more sensors, and wherein the at least one processor is further configured to receive the telematics data from the user device.

6. The computing device of claim 1, wherein the at least one processor is further configured to:
prompt, via the user interface displayed by the user device, the user to input driving data; and
receive the input driving data from the user device.

7. The computing device of claim 1, wherein the at least one processor is in communication with an external driver database, and wherein the at least one processor is configured to retrieve driver data from the external driver database.

8. The computing device of claim 1, wherein the processor is further configured to train the artificial intelligence model based upon the historical driver data.

9. The computing device of claim 1, wherein the processor is further configured to predict, using the artificial intelligence model, one or more of a periodic energy cost or a periodic carbon emission of the at least one target vehicle model.

10. The computing device of claim 9, wherein the artificial intelligence model is configured to generate the recommendation based at least in part upon the predicted periodic energy cost or the predicted periodic carbon emission of the at least one target vehicle model.

11. The computing device of claim 9, wherein the at least one processor is further configured to cause the user device to display the predicted periodic energy cost or the predicted periodic carbon emission of the at least one target vehicle model within the user interface.

12. The computing device of claim 9, wherein the at least one processor is further configured to predict, using the artificial intelligence model, one or more of a periodic energy cost or a periodic carbon emission of a reference vehicle model.

13. The computing device of claim 12, wherein the artificial intelligence model is configured to generate the recommendation based at least in part upon a caparison between the predicted periodic energy cost or the predicted periodic carbon emission of the at least one target vehicle model and the predicted periodic energy cost or the predicted periodic carbon emission of the reference vehicle model.

14. The computing device of claim 12, wherein the reference vehicle model is a current vehicle model of the user input by the user via the user interface.

15. The computing device of claim 12, wherein the at least one processor is further configured to cause the user device to display the predicted periodic energy cost or the predicted periodic carbon emission of the reference vehicle model within the user interface.

16. The computing device of claim 1, wherein the at least one processor is further configured to modify the populated data form based upon an instruction received from the user device.

17. A computer-implemented method for generating environmental impact predictions for vehicles, the computer-implemented method performed by a computing device including at least one processor and at least one memory device, the computer-implemented method comprising:
prompting, via a user interface displayed by a user device associated with a user, the user to input at least one target vehicle model;
receiving, from the user device, the at least one target vehicle model;
retrieving, from at least one data source, driver data relating to driving habits of the user;
populating a data form stored in the at least one memory device with the retrieved driving data;
generating, using an artificial intelligence model, a recommendation relating to the at least one target vehicle model based upon the populated data form, wherein the artificial intelligence model is trained based upon historical driver data relating to a plurality of drivers; and
causing the user device to display the generated recommendation within the user interface.

18. The computer-implemented method of claim 17, wherein the generated recommendation is one of a recommendation to purchase the at least one target vehicle model, a recommendation not to purchase the target vehicle, or a recommendation to input further driver data.

19. The computer-implemented method of claim 17, wherein the driver data includes telematics data collected by one or more sensors, and wherein the user device or a vehicle controller includes the one or more sensors.

20. At least one non-transitory computer-readable media having computer-executable instructions embodied thereon, wherein when executed by a computing device including at least one processor and at least one memory device, the computer-executable instructions cause the at least one processor to:
prompt, via a user interface displayed by a user device associated with a user, the user to input at least one target vehicle model;
receive, from the user device, the at least one target vehicle model;
retrieve, from at least one data source, driver data relating to driving habits of the user;
populate a data form stored in the at least one memory device with the retrieved driving data;
generate, using an artificial intelligence model, a recommendation relating to the at least one target vehicle model based upon the populated data form, wherein the artificial intelligence model is trained based upon historical driver data relating to a plurality of drivers; and
cause the user device to display the generated recommendation within the user interface.
